(19) United States
(12) Patent Application Publication
(10) Pub. No.: US 2022/0331829 A1
(43) Pub. Date: Oct. 20, 2022

(54) APPARATUS AND METHOD FOR MULTI-DIRECTIONAL SPRAY BOTTLE NOZZLE

(71) Applicant: Dwight Moret, Hillsboro, OR (US)

(72) Inventor: Dwight Moret, Hillsboro, OR (US)

(21) Appl. No.: 17/721,641

(22) Filed: Apr. 15, 2022

Related U.S. Application Data
(60) Provisional application No. 63/175,150, filed on Apr. 15, 2021.

(51) Int. Cl. B05B 15/652

(52) U.S. Cl. CPC B05B 15/652

(57) ABSTRACT

A system and method for a variable direction spray nozzle is provided. One embodiment comprises a coupling portion disposed at a proximal end of the variable direction spray nozzle; an outlet portion disposed at a distal end of the variable direction spray nozzle; and a flexible portion disposed between the coupling portion and the outlet portion of the variable direction spray nozzle, wherein the coupling portion is configured to secure to a spray outlet of a spray bottle, wherein the flexible portion is flexible so that the outlet portion of the variable direction spray nozzle may be oriented by a user of the spray bottle in a direction of interest, and wherein the flexible portion is resilient such that the direction of interest of the outlet portion of the variable direction spray nozzle is maintained after the user has completed the orientation of the outlet portion.

### PRIORITY CLAIM

This application claims priority to copending U.S. Provisional Application, Ser. No. 63/175,150, filed on Apr. 15, 2021, entitled APPARATUS AND METHOD FOR MULTI-DIRECTIONAL SPRAY BOTTLE NOZZLE, which is hereby incorporated by reference in its entirety for all purposes.

### BACKGROUND OF THE INVENTION

Spray bottles are commonly used for directing spray of a liquid onto a surface or into the air. Often, such legacy spray bottles include a hand pump that generates a pressure that propels the fluid therein out from a nozzle. The nozzle of the spray bottle is fluidly coupled to a tube, hose or the like that extends down towards the bottom of the spray bottle container portion. The liquid in the spray bottle gathers in the lowest part of the spray bottle (due to gravity). So long as the intake end of the spray bottle tube is below the surface level of the fluid, fluid can be drawn upward through the tube and be propelled out from the nozzle. Typically, when the spray bottle is vertically oriented, the spray nozzle propels the spray outward in a substantially horizontal direction. So long as the spray bottle is held in the vertical orientation, the intake end of the spray bottle tube remains submerged below the surface of the fluid to that the fluid can be propelled from the spray bottle in the horizontal direction.

However, at times, the user may wish to propel the spray in an upward direction, a downward direction, or at some other non-horizontal direction. To spray the fluid in such non-horizontal directions, the user of the spray bottle must orient the spray bottle in a non-vertical orientation since the nozzle is secured in a fixed position. When the spray bottle container is held in a non-vertical orientation, it is likely that the intake end of the spray bottle tube may no longer be below the surface of the liquid. Accordingly, operation of the spray bottle fails because the fluid can no longer be drawn into the intake end of the tube.

Accordingly, in the arts of spray bottle devices, there is a need in the arts for improved methods, apparatus, and systems for enabling a user to propel the liquid in any desired direction while maintain the spray bottle in a vertical, or substantially vertical, orientation.

### SUMMARY OF THE INVENTION

A system and method for a variable direction spray nozzle is provided. One embodiment comprises a coupling portion disposed at a proximal end of the variable direction spray nozzle; an outlet portion disposed at a distal end of the variable direction spray nozzle; and a flexible portion disposed between the coupling portion and the outlet portion of the variable direction spray nozzle, wherein the coupling portion is configured to secure to a spray outlet of a spray bottle, wherein the flexible portion is flexible so that the outlet portion of the variable direction spray nozzle may be oriented by a user of the spray bottle in a direction of interest, and wherein the flexible portion is resilient such that the direction of interest of the outlet portion of the variable direction spray nozzle is maintained after the user has completed the orientation of the outlet portion.

### BRIEF DESCRIPTION OF THE DRAWINGS

The components in the drawings are not necessarily to scale relative to each other. Like reference numerals designate corresponding parts throughout the several views.

FIG. 1 is a diagram of a variable direction spray nozzle coupled to a spray bottle.

FIG. 2 is a side view of the variable direction spray nozzle with the nozzle oriented in a downward direction.

FIG. 3 is a side view of the variable direction spray nozzle with the nozzle oriented in a substantially horizontal direction.

FIG. 4 is side view of the variable direction spray nozzle with the nozzle oriented in an upward direction.

FIG. 5 is a diagram of an alternative embodiment of a variable direction spray nozzle.

FIG. 6 is an exploded diagram of an alternative embodiment of a variable direction spray nozzle.

### DETAILED DESCRIPTION

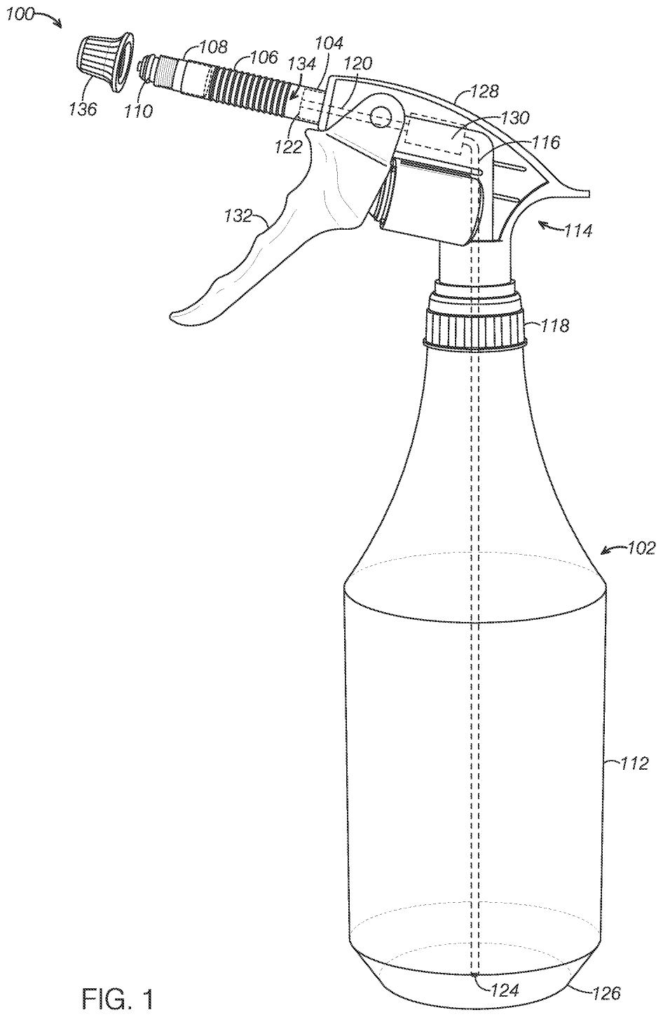

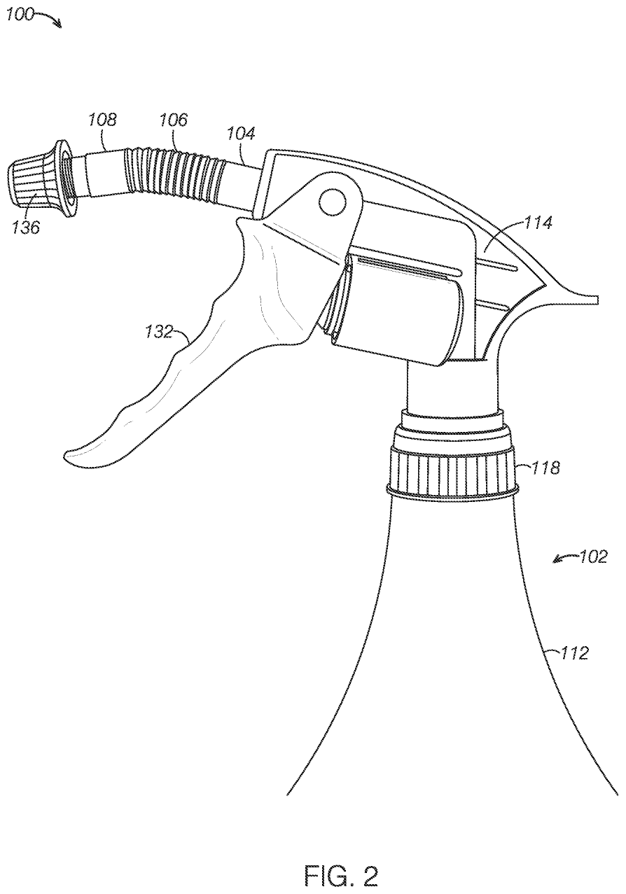

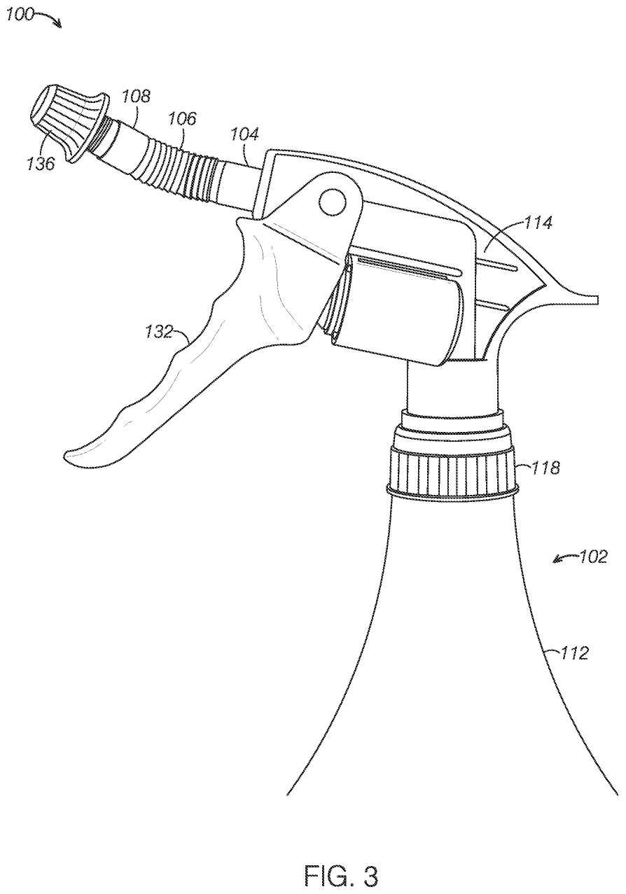

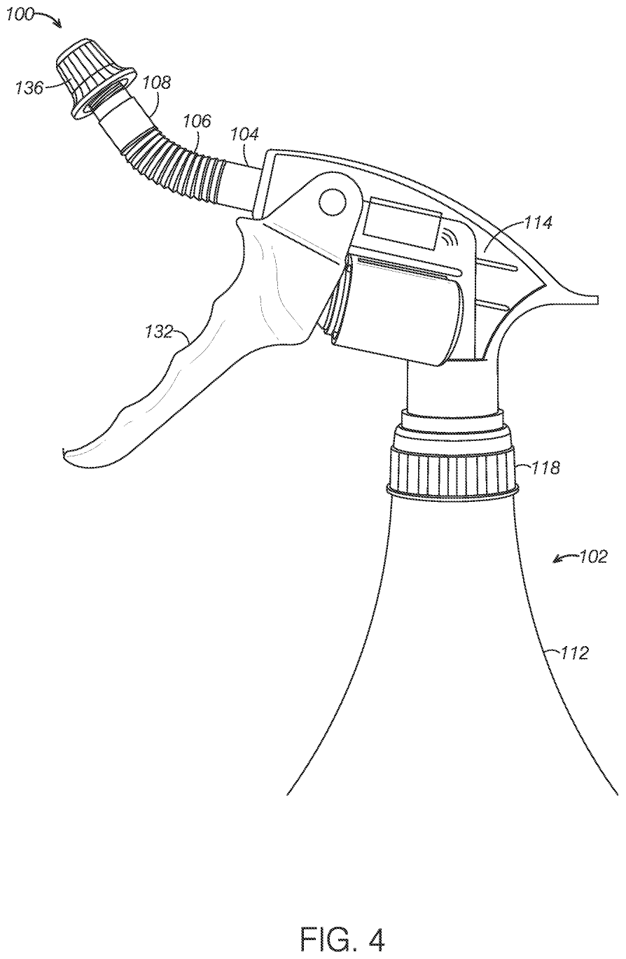

FIG. 1 is a diagram of a variable direction spray nozzle 100 coupled to a spray bottle 102. FIG. 2 is a side view of the variable direction spray nozzle 100 with the nozzle 110 oriented in a downward direction. FIG. 3 is a side view of the variable direction spray nozzle 100 with the nozzle 110 oriented in a substantially horizontal direction. FIG. 4 is side view of the variable direction spray nozzle 100 with the nozzle 110 oriented in an upward direction. In the various embodiments, the user is able to orient the variable direction spray nozzle 100 in any desired direction while maintaining the spray bottle 102 in a vertical orientation or another orientation of interest.

The disclosed systems and methods for a variable direction spray nozzle 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for a variable direction spray nozzle 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”. “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components. Any suitable securing means, such as threads, screws, frictional fittings, crimped fittings, or the like may be used by the various embodiments.

“Fluidly coupled” means that a first element is in fluid communication with a second element such that a fluid moves from the first element to the second element.

Returning to FIG. 1, an example embodiment of the variable direction spray nozzle 100 comprises a proximal coupling portion 104, a flexible portion 106, an outlet portion 108 and an optional nozzle 110. The non-limiting example spray bottle 102 comprises a liquid container portion 112, a pump portion 114, and a fluid tube 116.

In some spray bottles 102, the liquid container portion 112 and the pump portion 114 may be optionally releasably secured together with a coupling means 118. The pump portion 114 of the spray bottle 102 can then be removed so that replacement liquid can be added into the liquid container portion 112.

The proximal end 120 of the fluid tube 116 is secured to, and is in fluid communication with, an outlet 122 of the spray bottle 102. In some legacy spray bottles 102, the outlet 122 is formed as a nozzle. In other legacy spray bottles 102, the outlet 122 is fluidly coupled to a removeable nozzle 136.

The distal end 124 of the fluid tube 116 extends downward so as to be in close proximity of the bottom 126 of the liquid container portion 112 of the spray bottle 102. When liquid is in the liquid container portion 112 of the spray bottle 102, the distal end 124 of the fluid tube 116 extends below the surface of the liquid.

The pump portion 114 comprises a pump body 128, a pump device 130, and a pump actuator 132. The pump body 128 is a rigid, or substantially rigid, structure that supports the outlet 122, the fluid tube 116, the pump device 130 and the pump actuator 132. In the various embodiments, compression of the pump actuator 132 by the user causes the pump device 130, which is in fluid communication with the fluid tube 116, to draw the fluid residing in the liquid container portion 112 of the spray bottle 102 into the distal end 124 of the fluid tube 116. Continued actuation of the pump actuator 132 causes the fluid to be transported up through the fluid tube 116 and to be propelled out through the outlet 122 due to the liquid pressure that is generated by actuation of the pump actuator 132.

Pressurized spray bottles 102 may be similarly constructed, but omit the pump actuator 132 and pump device 130. A pressurized gas resides within the liquid container portion 112 of the spray bottle 102 along with the fluid. The outlet 122 is formed such that when the user applies pressure to the outlet 122, the liquid is propelled out of the outlet 122 by the pressurized gas.

The proximal coupling portion 104 of the variable direction spray nozzle 100 is secured to, and is in fluid communication with, the outlet 122 of the spray bottle 102. In some legacy spray bottles 102, the outlet 122 is formed as a nozzle. Here, the inner diameter of the coupling portion 104 corresponds to an outer diameter of the spray nozzle of the outlet 122 of the spray bottle 102. Accordingly, some embodiments of the variable direction spray nozzle 100 have a proximal coupling portion 104 that is configured to slide over the spray bottle nozzle using a fluid tight (water tight) frictional fit. Fluid pumped from the spray bottle 102 can then be passed through the variable direction spray nozzle 100 without leakage between the outlet 122 of the spray bottle 102 and the proximal coupling portion 104 of the variable direction spray nozzle 100.

With some types of legacy spray bottles 102, a nozzle 136 of the spray bottle 102 may be removably secured to the outlet 122 using a suitable connector, such as threaded connectors. The user may detach the nozzle 110 from the outlet 122. Here, interior threads of the nozzle 136 correspond to threads on the outside surface of the outlet 122 of the spray bottle 102. Accordingly, the spray bottle nozzle 136 can be simply unscrewed and removed from the outlet 122 of the spray bottle 102. In some embodiments of the variable direction spray nozzle 100, the inner diameter of the coupling portion 104 corresponds to an outer diameter of the spray outlet 122 of the spray bottle 102. Other attachment means may be used to secure the nozzle 136 to the outlet 122, such as a frictional fit as encountered in legacy paint spray cans, insect spray cans, or other pressurized spray cans.

In some embodiments, the inside surface of the proximal coupling portion 104 may be threaded with threads that match (correspond to) the threading on the outside surface of the outlet 122 of the spray bottle 102. The variable direction spray nozzle 100 may then be secured by mateably threading the proximal coupling portion 104 onto the outlet 122 of the spray bottle 102.

An unexpected benefit is that spray OEM (original equipment manufactured) nozzles 136 that are designed specifically to operate with a particular fluid (such as when the spray bottle with fluid is bought at a store) may be re-used by embodiments of the variable direction spray nozzle 100. For example, the size of the aperture of the nozzle may be designed to optimally spray the liquid having known viscosity characteristics, such as paint, liquid cleaners, oil, or the like. The nozzle 136 may provide a predefined spray pattern and/or spray amount. By removing the specifically designed nozzle 136 from the outlet 122, and then reusing the specifically designed nozzle 136 as the nozzle end of the variable direction spray nozzle 100, the fluid with known viscosity characteristics may be optimally sprayed out from the variable direction spray nozzle 100.

Optionally, the outlet portion 108 of the variable direction spray nozzle 100 may have threads on its outside surface that correspond to the internal threads of the nozzle 136 that has been removed from the spray bottle 102. The nozzle may be threaded onto the outlet portion 108 of the variable direction spray nozzle 100 to form a liquid tight seal between the nozzle 136 and the outlet portion 108. In use, the pattern of spray and/or amount of spray provided by the unmodified spray bottle 102 may be maintained during use of the variable direction spray nozzle 100 since the original nozzle 136 is used with the variable direction spray nozzle 100.

Embodiments of the variable direction spray nozzle 100 that have a proximal coupling portion 104 that is configured to be slidably secured over an existing spray bottle nozzle 136, and embodiments of the variable direction spray nozzle 100 that are threadedly secured to the outlet 122 of the spray bottle 102, are ideally suited to marketing as flexible extensions to legacy spray bottles 102. Some embodiments may be sold with a plurality of different proximal coupling portions 104, wherein each different proximal coupling portion 104 is configured to secure the variable direction spray nozzle 100 to a different type of outlet 122. For example, different proximal coupling portions 104 may have differently sized threads that are complimentary with commonly encountered threading on outlets 122 of different spray bottles 102. Alternatively, or additionally, different proximal coupling portions 104 may be provided to frictionally fit over different sized and/or shaped nozzles 136.

Additionally, or alternatively, embodiments the outlet portion 108 of the variable direction spray nozzle 100 may have a threaded exterior surface configured to couple to a variety of different threaded nozzles. Each different threaded nozzle may provide for a different spray pattern and/or spray volume. The user may then select a particular nozzle of interest, which may in include the original nozzle 136, to spray fluid in a desire spray pattern and/or amount. Further, embodiments of the variable direction spray nozzle 100 may be used at other times with multiple different spray bottles 102.

In some applications, embodiments of the variable direction spray nozzle 100 may be provided with a spray bottle 102 at the time of purchase by the user. Here, molding or another fabrication process may be used to secure the proximal coupling portion 104 to the outlet 122 prior to sale to a customer.

When initially used, it is likely that there is no fluid within the variable direction spray nozzle 100. As the pump portion 114 is operated to draw the fluid up from the liquid container portion 112, the fluid that is output from the outlet 122 is received into the interior cavity 134 of the variable direction spray nozzle 100. As pumping continues, the interior cavity 134 of the variable direction spray nozzle 100 fills with the liquid. When the interior cavity 134 of the variable direction spray nozzle 100 is full, liquid pressure builds up within the interior cavity 134 of the variable direction spray nozzle 100 as the pumping process continues. At some point, when the pressure within the interior cavity 134 of the variable direction spray nozzle 100 has been built up to some threshold value, the liquid is propelled outwardly from the nozzle 110 as a spray.

In some example embodiments, the flexible portion 106 of the variable direction spray nozzle 100 has a portion that is made of a flexible or semi-flexible material. In a preferred embodiment, the flexible portion 106 includes a plurality of adjacent pleats, which are bends fabricated into a portion of a tube or pipe. The section of the flexible portion 106 with the pleats is flexible, and retains its shape after the user has bent the flexible portion 106 such that the direction of interest of the outlet portion of the variable direction spray nozzle is maintained after the user has completed the orientation of the outlet portion. For example, after the user has bent the flexible portion 106 is an upward direction, as illustrated in FIG. 4, the nozzle 110 of the variable direction spray nozzle 100 remains upwardly pointed during use of the spray bottle 102.

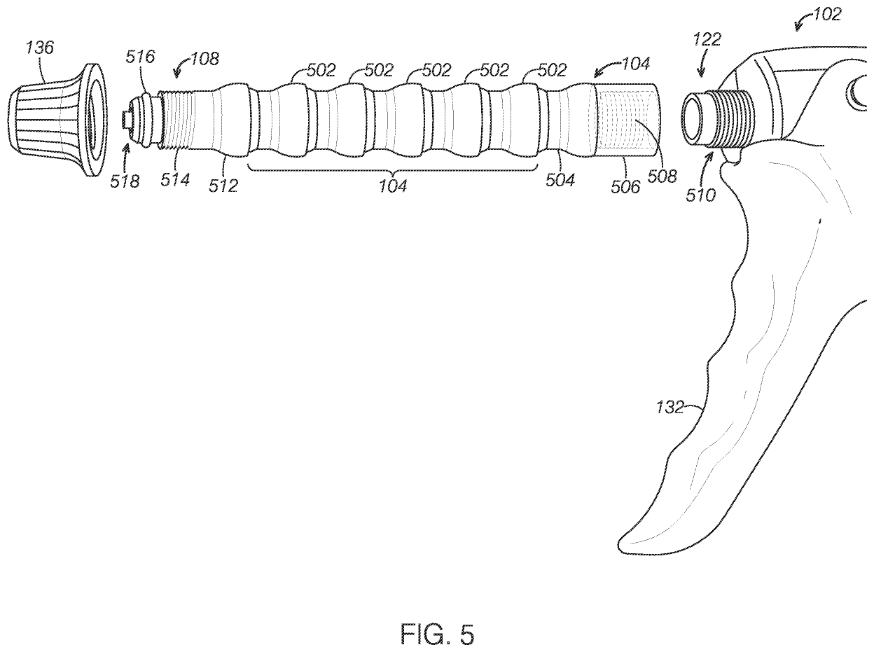

FIG. 5 is a diagram of an alternative embodiment of a variable direction spray nozzle that uses an alternative bending means in the flexible portion 106. Here, a series of ball and socket units 502 are interconnected with, and are fluidly coupled to, each other to form the proximal coupling portion 104. The ball and socket units 502 are defined by a length. The total length of the variable direction spray nozzle 100 may be defined based on the number of ball and socket units 502 used to form the flexible portion 106 of the variable direction spray nozzle 100. In the non-limiting example embodiment illustrated in FIG. 5, five ball and socket units 502 are used in the flexible portion 106 of the variable direction spray nozzle 100.

Each ball and socket unit 502 includes a ball portion at one end of the ball and socket unit 502. The ball of a ball and socket unit 502 is configured to frictionally and rotatably fit within the socket of an adjacent ball and socket unit 502. The rotatable fit between the ball and the socket of adjacent ball and socket units 502 allow a series of ball and socket units 502 to form the adjustable flexible portion 106 of the variable direction spray nozzle 100.

Each of the ball and socket units 502 have an aperture (hole) along its longitudinal axis. When a series of ball and socket units 502 are coupled together, the apertures align to permit passage of a fluid through the aligned apertures. The ball and sockets of the plurality of ball and socket units 502 have a frictional fit that provides a fluid tight, leak free flexible portion 106 that is adjustable.

The proximal coupling portion 104 of the variable direction spray nozzle 100 is defined by a distal ball member 504 that is configured to fit within the socket of the adjacent ball and socket unit 502 to form a fluid tight frictional fit (that may be optionally adjustable). In the illustrated example embodiment, the proximal end member 506 of the proximal coupling portion 104 has a threaded interior surface that has a plurality of threads 508 (e.g.; a single spiraling thread) corresponding to the plurality of threads 510 of the outlet 122 of the spray bottle 102. After the original nozzle 136 has been removed from the outlet 122 of the spray bottle 102, the threaded proximal end of the proximal coupling portion 104 may be threaded onto the threads of the outlet 122 of the spray bottle 102 to secure the variable direction spray nozzle 100 to the spray bottle 102 with a fluid tight seal.

The outlet portion 108 is defined by a distal socket member 512 that is configured to fit around the ball of the adjacent ball and socket unit 502 to form a fluid tight frictional fit (that may be optionally adjustable). The proximal end member 514 of the outlet portion 108 has a threaded exterior surface that has threads corresponding to the threads of an optional nozzle, such as the original nozzle 136 of the spray bottle 102 or another provided nozzle having a spray pattern and/or spray amount of interest. Alternatively, the proximal end member 514 of the outlet portion 108 may be configured to provide a frictional fluid tight connection with a nozzle, or be formed as a nozzle itself.

Optionally, a flexible O-ring seal 516 may be disposed around the outer surface of the distal end member 514 of the outlet portion 108. When the nozzle 136, or another provided nozzle, is securely threaded onto the outlet portion 108 of the variable direction spray nozzle 100, the O-ring seal 516 facilitates a fluid tight seal. Any suitable O-ring seal 516 now known or later developed may be used in the various embodiments.

In some embodiments, a small outlet nozzle 518 may be optionally fabricated into the outlet of the outlet portion 108 of the variable direction spray nozzle 100. Accordingly, the variable direction spray nozzle 100 may be used without the nozzle 136 or another nozzle. Alternatively, or additionally, the small outlet nozzle 518 may be used to facilitate fluid flow through the nozzle 136 or another nozzle.

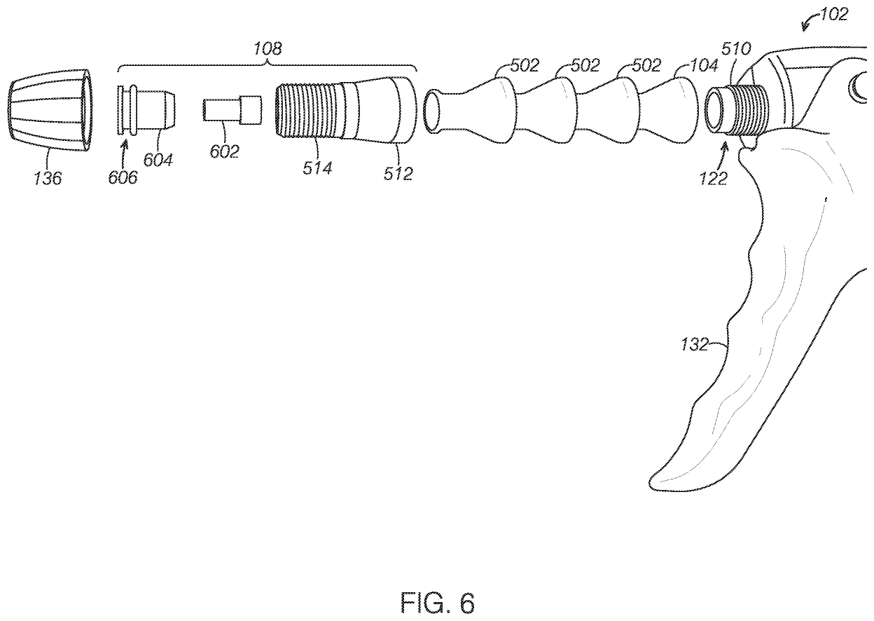

FIG. 6 is an exploded diagram of another alternative embodiment of a variable direction spray nozzle. Here, a series connected plurality of ball and socket units 502 for the flexible portion 106 of the variable direction spray nozzle 100 are used to define a desired length of the variable direction spray nozzle 100.

The outlet portion 108 includes a check valve 602 that maintains fluid pressure within the interior of the proximal coupling portion 104 during use of the spray bottle 102. A retainer member 604 retains the check valve 602. Any suitable check valve 602 and/or retainer member 604 now known or later developed may be used in the various embodiments.

If an O-ring seal 516 (FIG. 5) is used, the retainer member 604 may include an O-ring seal track or groove 606. The O-ring seal track or groove 606 is configured to retain the O-ring seal (not shown) in position.

In practice, if the user wishes to spray the fluid in an upward direction, the user simply bends the flexible portion 106 of the variable direction spray nozzle 100 so that the nozzle 110 is oriented in an upward direction. During use, the fluid is propelled upwardly out through the nozzle while the spray bottle 102 is held in a vertical, or substantially vertical, orientation. Accordingly, the distal end 124 of the fluid tube 116 remains below the surface level of the fluid in the liquid container portion 112 of the spray bottle 102 (since the spray bottle 102 is held in a vertical, or substantially vertical, orientation).

In some embodiments, the proximal coupling portion 104, the flexible portion 106, and outlet portion 108 may be formed as a unibody piece of material. Here, the outlet portion 108 of the variable direction spray nozzle 100 is slidably coupled to the nozzle 110 in a fluid tight manner. In other embodiments, the proximal coupling portion 104, the flexible portion 106, outlet portion 108 and the nozzle 110 may be formed as a unibody piece of material. Any suitable material may be used, such as plastic, metal or the like.

It should be emphasized that the above-described embodiments of the variable direction spray nozzle 100 are merely possible examples of implementations of the invention. Many variations and modifications may be made to the above-described embodiments. All such modifications and variations are intended to be included herein within the scope of this disclosure and protected by any later filed claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A variable direction spray nozzle, comprising:
a coupling portion disposed at a proximal end of the variable direction spray nozzle;
an outlet portion disposed at a distal end of the variable direction spray nozzle; and
a flexible portion disposed between the coupling portion and the outlet portion of the variable direction spray nozzle,
wherein the coupling portion is configured to secure to a spray outlet of a spray bottle,
wherein the flexible portion is flexible so that the outlet portion of the variable direction spray nozzle may be oriented by a user of the spray bottle in a direction of interest, and
wherein the flexible portion is resilient such that the direction of interest of the outlet portion of the variable direction spray nozzle is maintained after the user has completed the orientation of the outlet portion.

2. The variable direction spray nozzle of claim 1, further comprising:
a nozzle secured to the outlet portion of the variable direction spray nozzle.

3. The variable direction spray nozzle of claim 1, further comprising:
a nozzle removably secured to the outlet portion of the variable direction spray nozzle,
wherein the nozzle is detachable from the outlet portion of the variable direction spray nozzle.

4. The variable direction spray nozzle of claim 3,
wherein the nozzle is initially releasably secured to the spray outlet of the spray bottle, and
wherein the user removes the nozzle from the spray outlet of the spray bottle before the coupling portion is secured to the spray outlet of the spray bottle.

5. The variable direction spray nozzle of claim 1,
wherein an inner diameter of the coupling portion corresponds to an outer diameter of the spray outlet of the spray bottle,
wherein the coupling portion includes a plurality of threads on an interior surface of the coupling portion,
wherein the spray outlet of the spray bottle includes a plurality of corresponding threads, and
wherein the coupling portion is configured to mateably thread onto the corresponding threads of the spray outlet of the spray bottle.

6. The variable direction spray nozzle of claim 1,
wherein an inner diameter of the coupling portion corresponds to an outer diameter of the spray outlet of the spray bottle, and
wherein the coupling portion and the spray outlet engage to frictionally secure the variable direction spray nozzle to the spray outlet of the spray bottle.

7. The variable direction spray nozzle of claim 1,
wherein the spray outlet of the spray bottle comprises a spray nozzle,
wherein an inner diameter of the coupling portion corresponds to an outer diameter of the spray nozzle of the spray outlet of the spray bottle, and
wherein the coupling portion and the spray nozzle of the spray outlet engage to frictionally secure the variable direction spray nozzle to the spray outlet of the spray bottle.

8. The variable direction spray nozzle of claim 1, wherein the flexible portion comprises:
a plurality of ball and socket units that each have a ball portion and a socket portion,
wherein the ball portion of a first ball and socket unit is frictionally fit into a socket portion of an adjacent second ball and socket unit,
wherein the frictional fit between each ball portion and socket portion create a fluid tight fit, and
wherein the plurality of ball and socket units cooperatively bend so that the variable direction spray nozzle may be oriented by the user of the spray bottle in the direction of interest.

9. The variable direction spray nozzle of claim 8, wherein the coupling portion comprises:
a ball portion that is secured to the socket portion of an adjacent ball and socket unit, and
a proximal end member that has a threaded interior surface that has a plurality of threads corresponding to a plurality of threads on an outside surface of the outlet of the spray bottle.

10. The variable direction spray nozzle of claim 8, wherein the outlet portion comprises:
a socket portion that is secured to the ball portion of an adjacent ball and socket unit, and
a distal end member that has a threaded exterior surface that has a plurality of threads corresponding to a plurality of threads on an interior surface of a nozzle.

11. The variable direction spray nozzle of claim 1, wherein the flexible portion comprises:
a plurality of pleats that bend so that the variable direction spray nozzle may be oriented by the user of the spray bottle in the direction of interest.

12. A spray bottle with a variable direction spray nozzle, the spray bottle comprising:
a liquid container portion configured to contain a liquid;
a fluid tube defined by a proximal portion that extends downward into the liquid container portion; and
an outlet of the spray bottle coupled to a distal end of the fluid tube;
wherein the variable direction spray nozzle comprises:
a coupling portion disposed at a proximal end of the variable direction spray nozzle;
an outlet portion disposed at a distal end of the variable direction spray nozzle; and
a flexible portion disposed between the coupling portion and the outlet portion of the variable direction spray nozzle,
wherein the coupling portion is configured to secure to a spray outlet of a spray bottle,
wherein the flexible portion is flexible so that the outlet portion of the variable direction spray nozzle may be oriented by a user of the spray bottle in a direction of interest, and
wherein the flexible portion is resilient such that the direction of interest of the outlet portion of the variable direction spray nozzle is maintained after the user has completed the orientation of the outlet portion.

13. The spray bottle of claim 12,
wherein the liquid container portion is pressurized to force the liquid through the variable direction spray nozzle.

14. The spray bottle of claim 12, further comprising:
a pump portion that is secured between the distal end of the spray tube and the outlet of the spray bottle,
wherein the pump portion draws the liquid through the tube portion to force the liquid through the variable direction spray nozzle.
